(19) United States
(12) Patent Application Publication
(10) Pub. No.: US 2007/0225013 A1
(43) Pub. Date: Sep. 27, 2007

(54) Method and apparatus for managing an active set

(75) Inventors: Mark T. Pflum, Chandler, AZ (US); Jonathan H. Gross, Gilbert, AZ (US)

Correspondence Address: MOTOROLA, INC., LAW DEPARTMENT, 1303 E. ALGONQUIN ROAD, SCHAUMBURG, IL, 60196, US

(73) Assignee: MOTOROLA, INC.

(21) Appl. No.: 11/390,613

(22) Filed: Mar. 27, 2006

(51) Int. Cl. H04Q 7/20

(52) U.S. Cl. 455/452.2; 455/522; 455/517; 455/525

(57) ABSTRACT

A method and apparatus of managing an active set of a mobile station in a soft-handoff environment includes for a reverse link, comparing a reverse link quality metric to a reverse link quality threshold, where the reverse link is associated with a base station in the active set, and determining an aggregate reverse link quality metric corresponding to at least one base station that is a member of the active set but is not under consideration to be dropped from the active set. If the reverse link quality metric is below the reverse link quality threshold for a time period, the aggregate reverse link quality metric is compared to an aggregate reverse link quality threshold, and if the aggregate reverse link quality metric compares favorably to the aggregate reverse link quality threshold, the base station is removed from the active set.

### BACKGROUND OF INVENTION

Fundamental to a wireless communication system is the ability to maintain established communication connections while a mobile station (MS) moves in and between coverage areas. In order to maintain established communication connections, ‘soft-handoff’ techniques have been developed for communication systems whereby an MS is in concurrent, active communication with multiple Base Transceiver Stations (BTSs). Each BTS in active communication with the MS is a member of an ‘active set’ of the MS and transmits bearer traffic to, and/or receives bearer traffic from, the MS. As the MS moves through the communication system, BTSs are added to, or deleted from, the MS's active set so as to assure that the MS will always be in communication with at least one BTS.

In the prior art, a BTS may be dropped from the active set when the measured strength of a reverse link pilot signal drops below a reverse link pilot threshold for a given period of time, without any input from the MS, in order to reduce the size of the active set and conserve radio resources. Under rapidly changing or unbalanced radio frequency (RF) conditions this approach may cause the MS to request that the BTS just dropped be re-added to the active set. This causes unnecessary and unwanted signaling events, which can reduce performance of the wireless communication system. Also, under rapidly changing RF conditions, it is beneficial to maintain reverse link diversity and prematurely removing pilots from the active set could cause the BTS to lose reverse link diversity, thus increasing the probability that the system will drop a call.

Thus, a need exists to ensure that a communication link is not terminated, or dropped, as part of a soft-handoff until such time that the active set contains other adequate communication links.

### BRIEF DESCRIPTION OF THE DRAWINGS

Representative elements, operational features, applications and/or advantages of the present invention reside inter alia in the details of construction and operation as more fully hereafter depicted, described and claimed—reference being made to the accompanying drawings forming a part hereof, wherein like numerals refer to like parts throughout. Other elements, operational features, applications and/or advantages will become apparent in light of certain exemplary embodiments recited in the Detailed Description, wherein:

FIG. 1 representatively illustrates a block diagram of a wireless communication system of the prior art;

FIG. 2 representatively illustrates a block diagram of a wireless communication system in accordance with an exemplary embodiment of the present invention;

FIG. 3 representatively illustrates a logic flow diagram in accordance with an exemplary embodiment of the present invention; and

FIG. 4 representatively illustrates a logic flow diagram in accordance with another exemplary embodiment of the present invention.

Elements in the Figures are illustrated for simplicity and clarity and have not necessarily been drawn to scale. For example, the dimensions of some of the elements in the Figures may be exaggerated relative to other elements to help improve understanding of various embodiments of the present invention. Furthermore, the terms “first”, “second”, and the like herein, if any, are used inter alia for distinguishing between similar elements and not necessarily for describing a sequential or chronological order. Moreover, the terms “front”, “back”, “top”, “bottom”, “over”, “under”, and the like in the Description and/or in the Claims, if any, are generally employed for descriptive purposes and not necessarily for comprehensively describing exclusive relative position. Any of the preceding terms so used may be interchanged under appropriate circumstances such that various embodiments of the invention described herein may be capable of operation in other configurations and/or orientations than those explicitly illustrated or otherwise described.

### DETAILED DESCRIPTION OF EXEMPLARY EMBODIMENTS

The following representative descriptions of the present invention generally relate to exemplary embodiments and the inventor's conception of the best mode, and are not intended to limit the applicability or configuration of the invention in any way. Rather, the following description is intended to provide convenient illustrations for implementing various embodiments of the invention. As will become apparent, changes may be made in the function and/or arrangement of any of the elements described in the disclosed exemplary embodiments without departing from the spirit and scope of the invention.

For clarity of explanation, the embodiments of the present invention are presented, in part, as comprising individual functional blocks. The functions represented by these blocks may be provided through the use of either shared or dedicated hardware, including, but not limited to, hardware capable of executing software. The present invention is not limited to implementation by any particular set of elements, and the description herein is merely representational of one embodiment.

The terms “a” or “an”, as used herein, are defined as one, or more than one. The term “plurality,” as used herein, is defined as two, or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, an object code, a shared library/dynamic load library and/or other sequence of instructions designed for execution on a computer system. A component may include a computer program, software application, or one or more lines of computer readable processing instructions.

Software blocks that perform embodiments of the present invention can be part of computer program modules comprising computer instructions, such control algorithms that are stored in a computer-readable medium such as memory. Computer instructions can instruct processors to perform any methods described below. In other embodiments, additional modules could be provided as needed.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer.

Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

Wireless communication systems are well known and consist of many types including land mobile radio, cellular radiotelephone (inclusive of analog cellular, digital cellular, personal communication systems (PCS) and wideband digital cellular systems), and other communication system types. In cellular radiotelephone communication systems, for example, a number of communication cells are typically comprised of one or more Base Transceiver Stations (BTSs) coupled to one or more Base Station Controllers (BSCs) or Central Base Station Controllers (CBSCs) and forming a network access node. The BSCs or CBSCs are, in turn, coupled to a Mobile Switching Center (MSC) or data network which provides a connection between the network access node and an external network, such as a Public Switched Telephone Network (PSTN), as well as interconnection to other network access nodes. MSC is merely representative and a data network may be used in place of an MSC. Each BTS provides communication services to a mobile station (MS) located in a coverage area serviced by the BTS via a communication resource that includes a forward link for transmitting signals to, and a reverse link for receiving signals from, the MS.

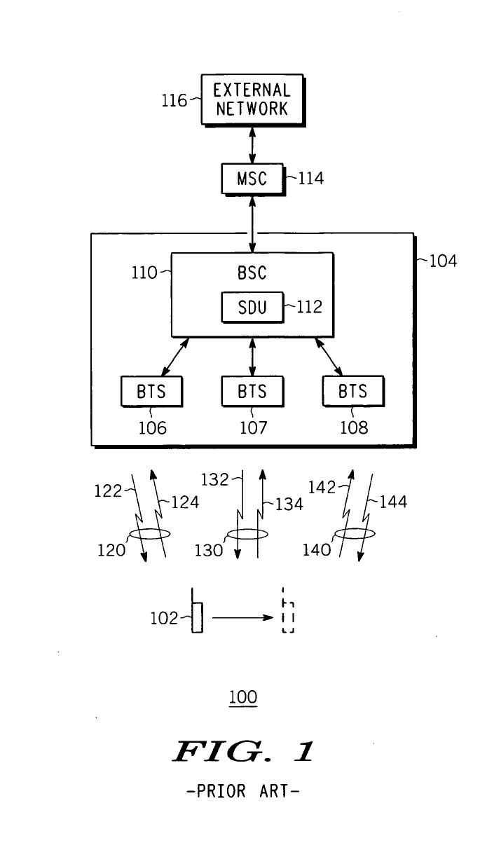

FIG. 1 representatively illustrates a block diagram of a wireless communication system 100 of the prior art. Wireless communication system 100 includes a network access node 104 comprising multiple BTSs 106-108 that are each coupled to a BSC 110. Network access node 104 may be coupled to an MSC 114 (or data network) and MSC 114 is in turn coupled to an external network 116 and provides a communication link between the external network, or other network access nodes, and network access node 104. Wireless communication system 100 further includes a MS 102 that concurrently is in active communication with each of BTS 106 and 107. That is, MS 102 is in ‘soft-handoff’ with each of BTSs 106 and 107 and each of BTS 106 and BTS 107 is a member of an ‘active set’ of MS 102. As members of the active set of MS 102, each BTS of BTSs 106 and 107 concurrently maintains a respective wireless communication link 120, 130 with the MS. Each communication link 120, 130 includes a respective forward link 122, 132, for conveyance of signals to MS 102 and a respective reverse link 124, 134, for receipt of signals from the MS, which may be concurrently active or may be rapidly switching between BTSs.

Each BTS 106, 107 in the active set of MS 102 conveys the same bearer traffic to, and receives the same bearer traffic from, the MS 102. By providing multiple BTSs that concurrently convey or rapidly switch same signals to, and receive same signals, from MS 102, wireless communication system 100 enhances the likelihood that the MS 102 will receive an acceptable quality signal from network access node 104 and that the network access node 104 will receive an acceptable quality signal from the MS 102.

For example, when each BTS of BTSs 106 and 107 receives a same frame from MS 102, the BTS determines whether the received frame is acceptable or erroneous and forwards the frame, and an accompanying indicator of whether the frame is acceptable, that is, good, or erroneous, to BSC 110. BSC 110, specifically a selection and distribution unit (SDU) 112 included in the BSC 110, then selects a version of the received frame from among the versions received from BTSs 106 and 107 and forwards the selected version to MSC 114 or data network.

As MS 102 heads towards a coverage area, or sector, associated with BTS 108, signal strength of a pilot signal received by MS 102 from BTS 108 via a forward link 142 associated with BTS 108 increases until MS 102 identifies the pilot signal from BTS 108 as a viable communication link. In addition, as MS 102 heads away from a coverage area, or sector, associated with BTS 106 a signal strength of a pilot signal received by MS 102 from BTS 106 via forward link 122 may deteriorate to the point that MS 102 determines that communication link 120 is no longer a viable communication link. MS 102 then requests that communication system 100 add BTS 108 to the MS's active set, that is, establish a communication link 140 associated with BTS 108, comprising forward link 142 and a reverse link 144, as an active communication link for transmitting data to, and receiving data from, MS 102, and drop BTS 106 from the active set, that is, terminate communication link 120. Typically, the request to drop a BTS is conveyed by MS 102 via a Pilot Strength Measurement Message (PSMM) or a RouteUpdate (RU) message. Upon receiving the drop request message, network access node 104 drops BTS 106 from the active set of MS 102 and terminates, or drops, communication link 120 between MS 102 and BTS 106.

Another means of dropping a BTS from the active set occurs as MS 102 heads away from a coverage area, or sector, associated with BTS 106 and the quality of reverse link 124 pilot signal received by BTS 106 from MS 102 deteriorates to the point that BTS 106 determines that communication link 120 is no longer a viable communication link. BTS 106 then requests that communication system 100 drop BTS 106 from the active set, that is, terminate communication link 120. Network access node 104 drops BTS 106 from the active set of MS 102 and terminates, or drops, communication link 120 between MS 102 and BTS 106. Typically, the decision to drop a BTS is conveyed by BTS 106 to MS 102 via handoff direction messages or traffic channel assignment message as is known in the art.

A decision to drop a communication link 120, 130, 140 and a corresponding BTS 106, 107, 108 from an active set may be based on a reverse link measurement, that is, a measurement of signal strength of a pilot signal received by a BTS, such as BTS 106, via a corresponding reverse link. That is, in making a drop decision, wireless communication system 100 does not take into account the performance of other reverse links in the active set or of forward links in the active set. A problem arises when MS 102 is in rapidly changing RF conditions where wireless links fade and regain strength rapidly. If the signal strength of a pilot signal from MS 102 to a BTS on a reverse link, such as reverse link 124, drops to a level sufficient to initiate dropping the corresponding BTS from the active set, there may not be other reverse links to adequately maintain the call. In other words, rapidly changing RF conditions may cause all reverse links to weaken and hence corresponding pilot signals on reverse links. In this situation, dropping the BTS from the active set may cause a call to be dropped or the BTS to be re-added to the active set when the MS comes out of a rapid fade condition.

To address the need for a method and an apparatus that checks the strength of one or more reverse links in the active set prior to dropping the BTS with the weakened reverse link, a communication system is provided that, when performing the soft-handoff, determines the strength of one or more reverse links in the active set, where the one or more reverse links do not correspond to the reverse link of the BTS being considered for termination from the active set of the mobile station.

Generally, an embodiment of the present invention encompasses a method for managing an active set of a mobile station and for performing a soft-handoff in a wireless communication system. The method addresses potential dropping of a BTS from an active set where the drop is initiated by a network access node and not a mobile station. The method includes for a reverse link, comparing a reverse link quality metric to a reverse link quality threshold, where the reverse link is associated with a base station in the active set. A network access node determines an aggregate reverse link quality metric corresponding to at least one base station that is a member of the active set but it not under consideration to be dropped from the active set. If the reverse link quality metric falls below the reverse link quality threshold for a time period, the aggregate reverse link quality metric is compared to an aggregate reverse link quality threshold. If the aggregate reverse link quality metric compares favorably to the aggregate reverse link quality threshold, the base station may be removed from the active set.

Another embodiment of the present invention further encompasses analyzing the strength of one or more of the forward links of the active set in addition to the strength of the reverse links. The method includes for a reverse link, comparing a reverse link quality metric to a reverse link quality threshold, where the reverse link is associated with a base station in the active set. A network access node determines an aggregate reverse link quality metric and an aggregate forward link quality metric corresponding to at least one base station that is a member of the active set but it not under consideration to be dropped from the active set. If the reverse link quality metric falls below the reverse link quality threshold for a time period, the aggregate reverse link quality metric is compared to an aggregate reverse link quality threshold, and the aggregate forward link quality metric is compared to an aggregate forward link quality threshold. If the aggregate reverse link quality metric compares favorably to the aggregate reverse link quality threshold, and the aggregate forward link quality metric compares favorably to the aggregate forward link quality threshold, the base station may be removed from the active set.

Another embodiment of the present invention encompasses an apparatus for performing a soft-handoff in a wireless infrastructure. The apparatus includes a processor that for a reverse link compares a reverse link quality metric to a reverse link quality threshold, where the reverse link is associated with a base station in the active set. The processor further determines an aggregate reverse link quality metric corresponding to at least one base station that is a member of the active set but is not under consideration to be dropped from the active set. At least one memory device maintains an aggregate reverse link quality threshold. If the if the reverse link quality metric falls below the reverse link quality threshold for a time period, the processor then compares the aggregate reverse link quality metric to the aggregate reverse link quality threshold. If the aggregate reverse link quality metric compares favorably to the aggregate reverse link quality threshold, the processor initiates removal of the base station from the active set.

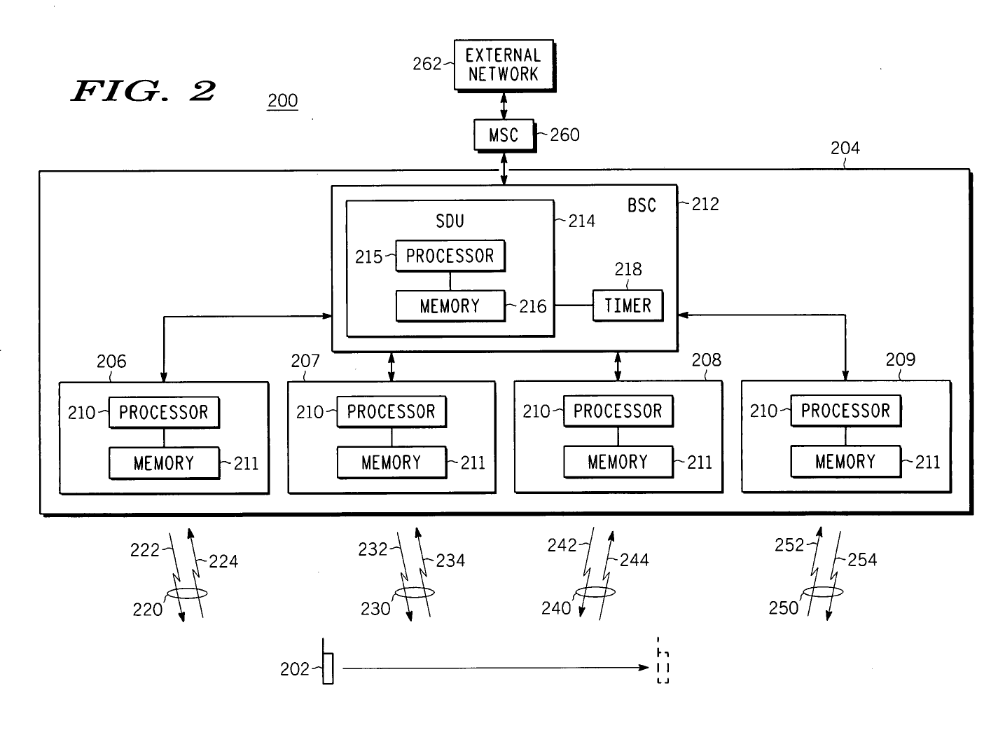

FIG. 2 representatively illustrates a block diagram of a wireless communication system 200 in accordance with an exemplary embodiment of the present invention. Similar to communication system 100, communication system 200 includes a network access node 204 comprising multiple Base Transceiver Stations (BTSs) 206-209 (four shown) that are each coupled to a controller 212, such as a Base Station Controller (BSC). Network access node 204 is coupled to a mobile switching center (MSC) 260 or data network and MSC 260 is in turn coupled to an external network 262 and provides a communication link between the external network 262, or other network access nodes (not shown), and network access node 204.

Each of the multiple BTSs 206-209 and controller 212, preferably a Selection and Distribution Unit (SDU) 214 included in the controller, comprises a respective processor 210, 215 such as one or more microprocessors, microcontrollers, digital signal processors (DSPs), combinations thereof or such other devices known to those having ordinary skill in the art. Each of the multiple BTSs 206-209 and controller 212 further includes a respective one or more memory devices 211, 216 respectively associated with the processor 210, 215, such as random access memory (RAM), dynamic random access memory (DRAM), and/or read only memory (ROM) or equivalents thereof, that store data and programs that may be executed by the processor. Controller 212 may further include a timer 218 that is coupled to SDU 214.

Wireless communication system 200 further includes a mobile station (MS) 202 that is concurrently in active communication with each BTS of multiple BTSs 206-209. That is, MS 202 is in ‘soft-handoff’ mode with the multiple BTSs 206-209 and each BTS of the multiple BTSs 206-209 is a member of an ‘active set’ of MS 202. As members of the active set of MS 202, each BTS of the multiple BTSs 206-209 concurrently maintains a respective wireless communication link 220, 230, 240, 250 with the MS 202. Each communication link 220, 230, 240, 250 includes a respective forward link 222, 232, 242, 252 for conveyance of signals to MS 202 and a respective reverse link 224, 234, 244, 254 for receipt of signals from the MS 202.

Preferably, wireless communication system 200 is a Code Division Multiple Access (CDMA) communication system, in which each of forward links 222, 232, 242, and 252 and reverse links 224, 234, 244, and 254 comprises multiple communication channels, such as access channels, control channels, paging channels, and traffic channels. Each communication channel of a reverse link 224, 234, 244, 254 or a forward link 222, 232, 242, 252 comprises an orthogonal code, such as a Walsh Code, that may be transmitted in a same frequency bandwidth as the other channels of the link. However, those who are of ordinary skill in the art realize that wireless communication system 200 may operate in accordance with any wireless telecommunication system, such as but not limited to a Global System for Mobile Communications (GSM) communication system, a Time Division Multiple Access (TDMA) communication system, a Frequency Division Multiple Access (FDMA) communication system, an Orthogonal Frequency Division Multiple Access (OFDM) communication system or a Evolution Data Only (EV-DO).

When wireless communication system 200 is operating in a soft-handoff mode, a first plurality of frames transmitted by MS 202 is received by each BTS of the multiple BTSs 206-209 in the active set of the MS via a respective reverse link 224, 234, 244, 254. Each BTS of the multiple BTSs 206-209 then forwards to BSC 212 the plurality of frames received by the BTS and further forwards one or more quality indicators that indicates a quality of the received plurality of frames.

The one or more quality indicators forwarded by each BTS 206-209 may be a reverse link quality metric that may be determined by the BTS on frame-by-frame basis or may be determined with respect to the plurality of frames. For example, the reverse link quality metric may be a frame error rate (FER) that is determined with respect to the plurality of frames, or may be based on a bit error rate (BER), a packet error rate (PER) a signal-to-noise ratio (SNR), a signal strength, a carrier-to-interference ratio (CIR), or an E_{b}/Iₒ ratio (energy per bit/interference power density (per Hertz)) that is determined with respect to one or more of the plurality of frames. Reverse link quality metric may be the strength of the pilot signal received from the MS by a BTS via its corresponding reverse link or may be the strength or quality of the traffic channel received via the reverse link. Those who are of ordinary skill in the art realize that many quality metrics are known and may be used herein without departing from the spirit and scope of the present invention.

BTS may determine, with respect to each frame and based on the reverse link quality metric, whether the received frame is acceptable or erroneous. The BTS embeds a quality indicator in a header of the frame, which quality indicator indicates whether the frame is acceptable, that is, good, or erroneous, that is, erased. The BTS then forwards the frame and the embedded quality indicator to BSC 212.

When BSC 212 receives a plurality of frames and an associated one or more reverse link quality metric from each of the multiple BTSs 206-209, the BSC 212 stores the one or more quality indicators in association with the BTS sourcing the plurality of frames and/or the reverse link or communication link via which the plurality of frames are received, in one or more memory devices 216. Upon receiving a same frame from each of the multiple BTSs 206-209, BSC 212 then selects a frame from among the same frames received from each of the BTSs and forwards the selected frame to MSC 260 or data network. Unless otherwise indicated herein, all functions performed herein by BSC 212 are preferably performed by SDU 214, and in particular by processor 215.

As MS 202 moves through communication system 200, the MS 202 may move away from a coverage area, or sector, associated with a BTS in the active set, such as BTS 206. As MS 202 heads away from BTS 206, a quality of reverse link 224 deteriorates to the point that BTS 206 determines that communication link 220 is no longer a viable communication link. At that point, communication system 200 determines whether to execute a soft-handoff by dropping BTS 206, along with associated communication link 220, from the active set of MS 202. Soft-handoff may also include adding another BTS to the active set (not shown) if a pilot signal transmitted over a forward link from a new BTS is determined to be strong enough by MS 202.

In an embodiment, as MS 202 moves away from BTS 206, the quality of reverse link 224 sent by MS 202 to BTS 206 becomes weaker. The strength of the reverse link 224 sent by MS 202 to BTS 206 may be determined using any of the reverse link quality metrics discussed above. In effect, BTS 206 measures a reverse link quality metric sent by MS 202. BTS 206 may compare the reverse link quality metric to a reverse link quality threshold. The reverse link quality threshold may be a value of the reverse link quality metric, below which communication link 220 is deemed too weak to stay in the active set of MS 202. In the prior art, if the reverse link quality metric was below the reverse link quality threshold for a time period per timer 218, BTS 206 was dropped from the active set of MS 202.

In an embodiment of the present invention, network access node 204, particularly BSC 212, may determine an aggregate reverse link quality metric corresponding to at least one base station that is a member of the active set but is not under consideration to be dropped from the active set. For example, aggregate reverse link quality metric may be determined using a reverse link quality metric from one or more of BTSs 207, 208, 209 using respective reverse links 234, 244, 254. Aggregate reverse link quality metric may include an average, weighted average, and the like, of the reverse link quality metric of one or more of the reverse links 234, 244, 254 of the BTSs 207, 208, 209 in the active set, where the BTSs used for the aggregate reverse link quality metric are not under consideration for dropping from the active set. Aggregate reverse link quality metric may also merely be the value of a reverse link quality metric of the strongest of the reverse links 234, 244, 254 or the weakest of the reverse links 234, 244, 254, and the like. In effect, the value of a reverse quality metric from one or more of reverse links 234, 244, 254 may be used or combined in any way to compute aggregate reverse link quality metric.

Aggregate reverse link quality metric may be an aggregate metric that is based on reverse link quality determinations for one or more of the reverse links 234, 244, 254 currently in a soft-handoff mode with MS 202 and that will remain in a soft-handoff mode with the MS 202 after a possible dropping of link 220. For example, BSC 212 may determine aggregate signal strengths for all such reverse links 234, 244, 254. BSC 212 may then compare the aggregate reverse link quality metric to an aggregate reverse link quality threshold.

In another embodiment of the present invention, BSC 212 may determine a reverse link quality metric by determining a quality of each reverse link 234, 244, 254 currently in a soft-handoff mode with MS 202 and that will remain in a soft-handoff mode with the MS 202 after a possible dropping of link 220, and further determining a best reverse link quality from among the multiple determined reverse link qualities. BSC 212 then compares the reverse link quality metric, that is, the best reverse link quality, to an aggregate reverse link quality threshold.

In an embodiment, aggregate reverse link quality threshold may be a value stored in one or memory devices 216. If the reverse link quality metric of the BTS under consideration for dropping from the active set (BTS 206) falls below the reverse link quality threshold for a time period, the aggregate reverse link quality metric may be compared to the aggregate reverse link quality threshold. If the aggregate reverse link quality metric compares favorably to the aggregate reverse link quality threshold, the base station (BTS 206) may be removed from the active set. Removing from the active set may include network access node 204 sending a remove base station message to MS 202, so that MS 202 may communicate to BSC 212 to remove communication link 220 and hence BTS 206 from the active set. If the aggregate reverse link quality metric compares unfavorably to the aggregate reverse link quality threshold, the BTS under consideration is maintained in the active set.

The aggregate reverse link quality metric comparing favorably may be the aggregate reverse link quality metric being above the aggregate reverse link quality threshold. This indicates that one or more of the reverse links not under consideration for dropping from the active set have sufficient signal strength such that it is alright to drop the BTS under consideration from the active set. The aggregate reverse link quality metric comparing unfavorably may be the aggregate reverse link quality metric being equal to or below the aggregate reverse link quality threshold. This indicates that one or more of the reverse links not under consideration for dropping from the active set do not have sufficient signal strength such that dropping the BTS under consideration may leave insufficient reverse link diversity or that most or all of the reverse links are in a weakened signal condition.

In an embodiment, aggregate reverse link quality threshold may be a function of the size of the active set. For example, prior to determining an aggregate reverse link quality metric, BSC 212 may determine a quantity of communication links, or reverse links, currently in soft-handoff mode with MS 202, that is, currently engaged in an active communication with MS 202. BSC 212 then may set the aggregate reverse link quality threshold based on the number of reverse links in the active set. For example, the greater number of reverse links in the active set, then the higher or lower aggregate reverse link quality threshold may be. In an exemplary embodiment, the greater number of reverse links currently in soft-handoff mode with MS 202, the lower aggregate reverse link quality threshold may be set, hence being more aggressive in dropping a reverse link with a weak reverse link quality metric from the active set.

In an embodiment, the time period at which reverse link quality metric of reverse link 222 must be below the reverse link quality threshold may be a function of the size of the active set and/or the aggregate reverse link quality metric. For example, the larger number of BTSs in the active set, the lower the time period may be set so as to be more aggressive in eliminating weak communication links from the active set. Also, the higher the aggregate reverse link quality metric, the shorter the timer period may be so as to be more aggressive in eliminating weak communication links from the active set. On the other hand, if the number of BTSs in the active set is relatively low and/or the aggregate reverse link quality metric is low, the time period may be higher so as to maintain reverse link diversity in an environment where there are few BTSs in the active set or the overall strength of each of the reverse links in the active set is low.

In the present invention described above, the respective strengths of the reverse links in the active set that are not under consideration for dropping are analyzed to determine if there are one or more sufficiently strong reverse links remaining in the active set if the reverse link under consideration is dropped from the active set. This additional check before dropping a communication link from the active set assures that during rapidly changing RF conditions, that a communication link is not inadvertently dropped and re-added, when in fact all reverse links are temporarily in a low signal strength condition.

In another embodiment of the present invention, the strengths of the forward links in the active set 222, 232, 242, 252, in addition to the strengths of the reverse links described above, may be considered prior to dropping a BTS from the active set. In an embodiment of the present invention, network access node 204, particularly BSC 212, may determine an aggregate forward link quality metric corresponding to at least one base station that is a member of the active set but is not under consideration to be dropped from the active set. Aggregate forward link quality metric may be determined using one or more of the parameters discussed above with reference to aggregate reverse link quality metric.

For example, aggregate forward link quality metric may be determined using a forward link quality metric from one or more of BTSs 207, 208, 209 using respective forward links 232, 242, 252. Aggregate forward link quality metric may include an average, weighted average, and the like, of the forward link quality metric of one or more of the forward links 232, 242, 252 of the BTSs 207, 208, 209 in the active set, where the BTSs used for the aggregate forward link quality metric are not under consideration for dropping from the active set. Aggregate forward link quality metric may also merely be the value of a forward link quality metric of the strongest of the forward links 232, 242, 252 or the weakest of the forward links 232, 242, 252, and the like. In effect, the value of a forward quality metric from one or more of forward links 232, 242, 252 may be used or combined in any way to compute aggregate forward link quality metric. In another embodiment, aggregate forward link quality metric may include all forward links, including the forward link of the BTS under consideration to be dropped from the active set.

Aggregate forward link quality metric may be an aggregate metric that is based on forward link quality determinations for one or more of the forward links 232, 242, 252 currently in a soft-handoff mode with MS 202 and that will remain in a soft-handoff mode with the MS 202 after a possible dropping of link 220. For example, BSC 212 may determine aggregate signal strengths for all such forward links 232, 242, 252. BSC 212 may then compare the aggregate forward link quality metric to an aggregate forward link quality threshold.

In another embodiment of the present invention, BSC 212 may determine a forward link quality metric by determining a quality of each forward link 232, 242, 252 currently in a soft-handoff mode with MS 202 and that will remain in a soft-handoff mode with the MS 202 after a possible dropping of link 220, and further determining a best forward link quality from among the multiple determined forward link qualities. BSC 212 then compares the forward link quality metric, that is, the best forward link quality, to an aggregate forward link quality threshold.

In an embodiment, aggregate forward link quality threshold may be a value stored in one or memory devices 216. If the reverse link quality metric of the BTS under consideration for dropping from the active set (BTS 206) falls below the reverse link quality threshold for a time period, the aggregate reverse link quality metric may be compared to the aggregate reverse link quality threshold and the aggregate forward link quality metric may be compared to the aggregate forward link quality threshold. If the aggregate reverse link quality metric compares favorably to the aggregate reverse link quality threshold, and the aggregate forward link quality metric compares favorably to the aggregate forward link quality threshold, the base station (BTS 206) may be removed from the active set. Removing from the active set may include network access node 204 sending a remove base station message to MS 202, so that MS 202 may send a message to BSC 212 to remove communication link 220 and hence BTS 206 from the active set. If the aggregate reverse link quality metric compares unfavorably to the aggregate reverse link quality threshold, or the aggregate forward link quality metric compares unfavorably to the aggregate forward link quality threshold, the BTS under consideration is maintained in the active set.

The aggregate reverse link quality metric comparing favorably may be the aggregate reverse link quality metric being above the aggregate reverse link quality threshold. The aggregate forward link comparing favorably may be the aggregate forward link quality metric being above the aggregate forward link quality threshold. This indicates that one or more of the reverse links not under consideration for dropping from the active set have sufficient signal strength such that it is alright to drop the BTS under consideration from the active set. Also, the corresponding forward links have sufficient signal strength that it is alright to drop the BTS under consideration from the active set. The aggregate reverse link quality metric comparing unfavorably may be the aggregate reverse link quality metric being equal to or below the aggregate reverse link quality threshold. Also, the aggregate forward link quality metric comparing unfavorably may be the aggregate forward link quality metric being equal to or below the aggregate forward link quality threshold. This indicates that one or more of the reverse links or forward links not under consideration for dropping from the active set do not have sufficient signal strength such that dropping the BTS under consideration may leave insufficient reverse link diversity and forward link diversity respectively, or that most or all of the reverse links and forward links are in a weakened signal condition.

Analogous to the reverse links above, aggregate forward link quality threshold may be a function of the size of the active set. BSC 212 may set the aggregate forward link quality threshold based on the number of forward links in the active set.

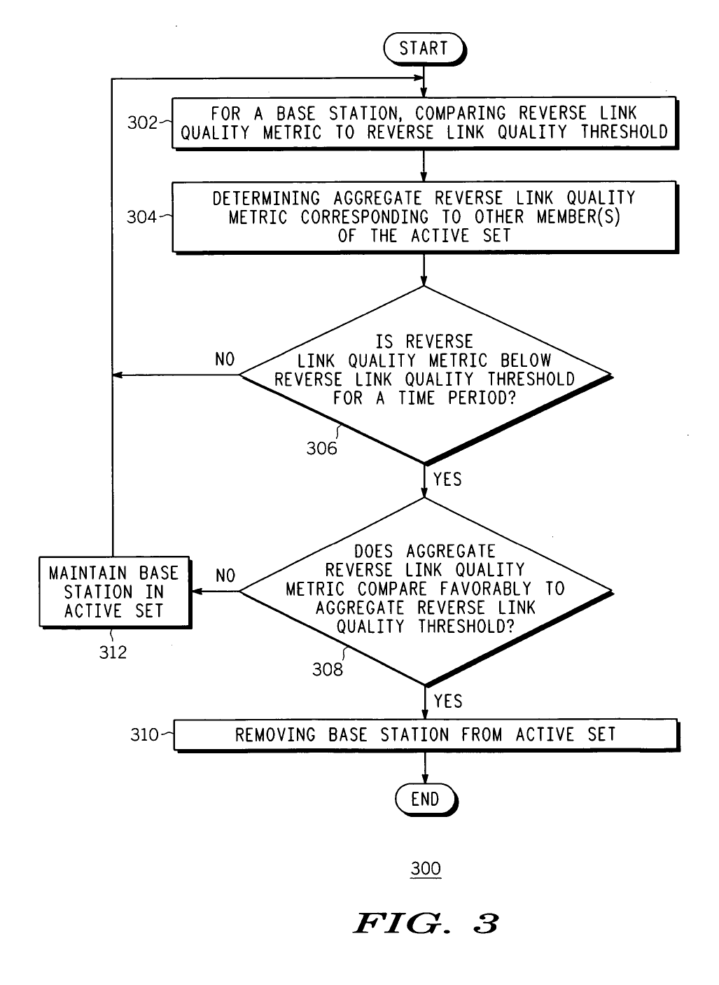

FIG. 3 representatively illustrates a logic flow diagram 300 in accordance with an exemplary embodiment of the present invention. FIG. 3 illustrates a method managing an active set during soft-handoff in a wireless communication system. In step 302, for the reverse link of a base station in an active set of a mobile station, a reverse link quality metric is compared to a reverse link quality threshold. In an embodiment, a pilot signal of the reverse link of the base station is compared to the reverse link quality metric. In step 304, a network access node determines an aggregate reverse link quality metric corresponding to at least one base station that is a member of the active set but is not under consideration to be dropped from the active set. In step 306, it is determined if the reverse link quality metric is below the reverse link quality threshold for a time period. If not, the process recycles to step 302 as shown. If reverse link quality metric is below the reverse link quality threshold for a time period, then the aggregate reverse link quality metric is compared to an aggregate reverse link quality threshold. In step 308 it is determined if the aggregate reverse link quality metric compares favorably to the aggregate reverse link quality threshold. If so, the BTS under consideration is removed from the active set in step 310. If the aggregate reverse link quality metric compares unfavorably to the aggregate reverse link quality threshold, then the BTS under consideration is maintained in the active set per step 312.

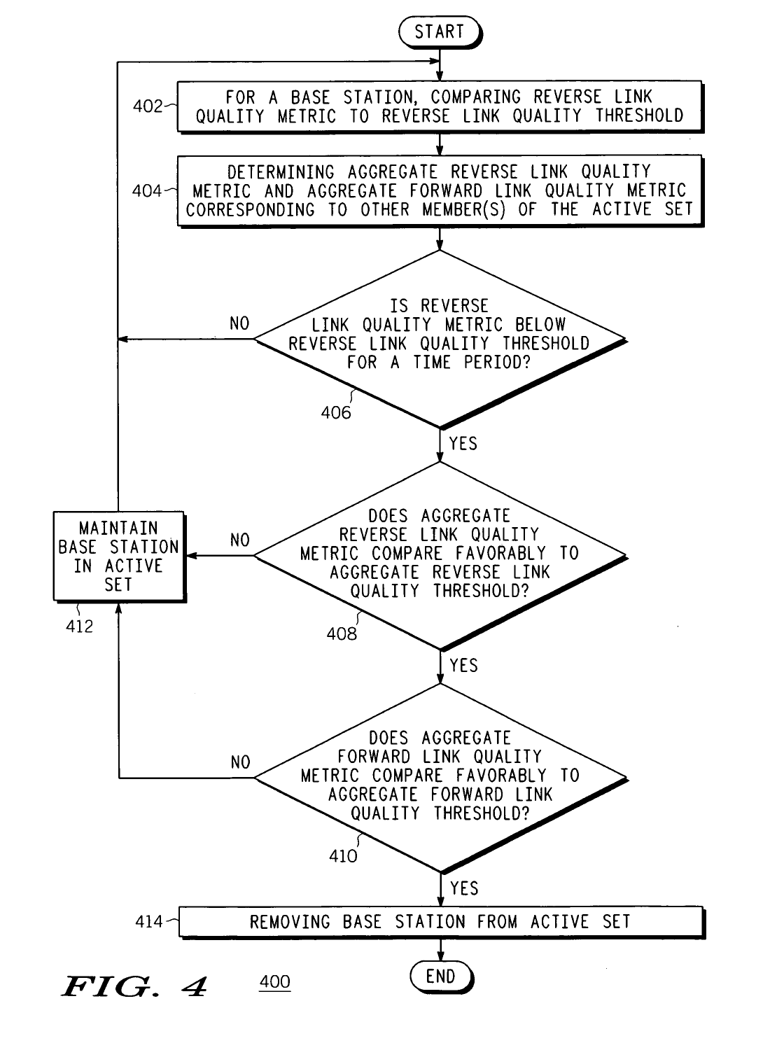

FIG. 4 representatively illustrates a logic flow diagram 400 in accordance with another exemplary embodiment of the present invention. FIG. 4 illustrates a method managing an active set during soft-handoff in a wireless communication system. In step 402, for the reverse link of a base station in an active set of a mobile station, a reverse link quality metric is compared to a reverse link quality threshold. In an embodiment, a pilot signal of the reverse link of the base station is compared to the reverse link quality metric. In step 404, a network access node determines an aggregate reverse link quality metric and an aggregate forward link quality metric corresponding to at least one base station that is a member of the active set but is not under consideration to be dropped from the active set. In step 406, it is determined if the reverse link quality metric is below the reverse link quality threshold for a time period. If not, the process recycles to step 402 as shown.

If reverse link quality metric is below the reverse link quality threshold for a time period, then the aggregate reverse link quality metric is compared to an aggregate reverse link quality threshold. In step 408 it is determined if the aggregate reverse link quality metric compares favorably to the aggregate reverse link quality threshold. If the comparison is favorable, then in step 410 it is determined if the aggregate forward link quality metric compares favorably to the aggregate forward link quality threshold. If both of the comparisons in steps 408 and 418 are favorable, the BTS under consideration is removed from the active set in step 414. If either of the comparisons in steps 408 and 410 are unfavorable, then the BTS under consideration is maintained in the active set per step 412.

The above method and apparatus has the benefit of decreasing a lost call (LC) rate by not prematurely removing weak pilot and their corresponding BTSs from the active set when an MS is in a rapidly changing RF environment. This is accomplished by maintaining reverse link diversity in a rapidly changing RF environment, which is essential to maintaining call connectivity.

In the foregoing specification, the invention has been described with reference to specific exemplary embodiments. However, it will be appreciated that various modifications and changes may be made without departing from the scope of the present invention as set forth in the claims below. The specification and figures are to be regarded in an illustrative manner, rather than a restrictive one and all such modifications are intended to be included within the scope of the present invention. Accordingly, the scope of the invention should be determined by the claims appended hereto and their legal equivalents rather than by merely the examples described above.

For example, the steps recited in any method or process claims may be executed in any order and are not limited to the specific order presented in the claims. Additionally, the components and/or elements recited in any apparatus claims may be assembled or otherwise operationally configured in a variety of permutations to produce substantially the same result as the present invention and are accordingly not limited to the specific configuration recited in the claims.

Benefits, other advantages and solutions to problems have been described above with regard to particular embodiments; however, any benefit, advantage, solution to problem or any element that may cause any particular benefit, advantage or solution to occur or to become more pronounced are not to be construed as critical, required or essential features or components of any or all the claims.

Other combinations and/or modifications of the above-described structures, arrangements, applications, proportions, elements, materials or components used in the practice of the present invention, in addition to those not specifically recited, may be varied or otherwise particularly adapted to specific environments, manufacturing specifications, design parameters or other operating requirements without departing from the general principles of the same.

We claim:

1. A method of managing an active set of a mobile station, comprising:
for a reverse link, comparing a reverse link quality metric to a reverse link quality threshold, wherein the reverse link is associated with a base station in the active set;
determining an aggregate reverse link quality metric corresponding to at least one base station that is a member of the active set but is not under consideration to be dropped from the active set;
if the reverse link quality metric is below the reverse link quality threshold for a time period, comparing the aggregate reverse link quality metric to an aggregate reverse link quality threshold; and
if the aggregate reverse link quality metric compares favorably to the aggregate reverse link quality threshold, removing the base station from the active set.

2. The method of claim 1, further comprising setting the aggregate reverse link quality threshold as a function of a size of the active set.

3. The method of claim 1, further comprising setting the time period as a function of at least one of a size of the active set and the aggregate reverse link quality metric.

4. The method of claim 1, further comprising if the aggregate reverse link quality metric compares unfavorably to the aggregate reverse link quality threshold, maintaining the base station in the active set.

5. The method of claim 1, further comprising:
determining an aggregate forward link quality metric corresponding to at least one base station that is a member of the active set but is not under consideration to be dropped from the active set;
if the reverse link quality metric is below the reverse link quality threshold for a time period, comparing the aggregate forward link quality metric to an aggregate forward link quality threshold; and
if the aggregate forward link quality metric compares favorably to the aggregate forward link quality threshold, removing the base station from the active set.

6. The method of claim 5, further comprising setting the aggregate forward link quality threshold as a function of a size of the active set.

7. The method of claim 1, wherein the steps of determining and comparing occurring at a network access node.

8. The method of claim 1, wherein removing the base station from the active set comprises sending a remove base station message to the mobile station.

9. A method of performing soft-handoff in a wireless communication system, comprising:
for a reverse link, comparing a reverse link quality metric to a reverse link quality threshold, wherein the reverse link is associated with a base station in an active set of a mobile station;
determining an aggregate reverse link quality metric and an aggregate forward link quality metric both corresponding to at least one base station that is a member of the active set but is not under consideration to be dropped from the active set;
if the reverse link quality metric is below the reverse link quality threshold for a time period, comparing the aggregate reverse link quality metric to an aggregate reverse link quality threshold, and comparing the aggregate forward link quality metric to an aggregate forward link quality threshold; and
if the aggregate reverse link quality metric compares favorably to the aggregate reverse link quality threshold and the aggregate forward link quality metric compares favorably to the aggregate forward link quality threshold, removing the base station from the active set.

10. The method of claim 9, further comprising setting the aggregate reverse link quality threshold as a function of a size of the active set.

11. The method of claim 9, further comprising setting the aggregate forward link quality threshold as a function of a size of the active set.

12. The method of claim 9, further comprising setting the time period as a function of at least one of a size of the active set and the aggregate reverse link quality metric.

13. The method of claim 9, further comprising if the aggregate reverse link quality metric compares unfavorably to the aggregate reverse link quality threshold or the aggregate forward link quality metric compares unfavorably to the aggregate forward link quality threshold, maintaining the base station in the active set.

14. The method of claim 9, wherein the steps of determining and comparing occurring at a network access node.

15. The method of claim 9, wherein removing the base station from the active set comprises sending a remove base station message to the mobile station.

16. In a wireless communication system, a network access node managing an active set of a mobile station, the network access node comprising:
a processor, that for a reverse link compares a reverse link quality metric to a reverse link quality threshold, wherein the reverse link is associated with a base station in the active set, wherein the processor further determines an aggregate reverse link quality metric corresponding to at least one base station that is a member of the active set but is not under consideration to be dropped from the active set; and
at least one memory device coupled to the processor and coupled to maintain an aggregate reverse link quality threshold, wherein if the reverse link quality metric is below the reverse link quality threshold for a time period, the processor compares the aggregate reverse link quality metric to the aggregate reverse link quality threshold, and wherein if the aggregate reverse link quality metric compares favorably to the aggregate reverse link quality threshold, the processor initiates removal of the base station from the active set.

17. The network access node of claim 16, wherein the processor sets the aggregate reverse link quality threshold as a function of a size of the active set.

18. The network access node of claim 16, wherein the processor sets the time period as a function of at least one of a size of the active set and the aggregate reverse link quality metric.

19. The network access node of claim 16, wherein if the aggregate reverse link quality metric compares unfavorably to the aggregate reverse link quality threshold, the processor maintains the base station in the active set.

20. The network access node of claim 16, wherein the processor determines an aggregate forward link quality metric corresponding to at least one base station that is a member of the active set but is not under consideration to be dropped from the active set, wherein if the reverse link quality metric is below the reverse link quality threshold for a time period, comparing the aggregate forward link quality metric to an aggregate forward link quality threshold maintained in the at least one memory device, and wherein if the aggregate forward link quality metric compares favorably to the aggregate forward link quality threshold, the processor initiating removal of the base station from the active set.
